(19) United States
(12) Patent Application Publication
(10) Pub. No.: US 2011/0048541 A1
(43) Pub. Date: Mar. 3, 2011

(54) Vacuum Saturation Technique for Porous Aggregate Material

(76) Inventors: Richard F. Wehrli, Naperville, IL (US); Joseph Gallione, Naperville, IL (US)

(21) Appl. No.: 12/873,842

(22) Filed: Sep. 1, 2010

Related U.S. Application Data
(60) Provisional application No. 61/239,064, filed on Sep. 2, 2009.

(51) Int. Cl. F17D 3/00; E03B 7/07; E03B 5/00

(52) U.S. Cl. 137/1; 137/544; 137/565.01

(57) ABSTRACT

A method of saturating porous aggregate material includes: (a) filling an interior of a vacuum vessel with porous aggregate material; (b) applying a vacuum to the vessel interior until a desired vacuum level is reached; (c) drawing water into the vessel under vacuum until substantially all of said aggregate material is covered; and (d) pumping unabsorbed water from the vacuum vessel. A system for saturating porous aggregate materials includes: (a) a vacuum vessel; (b) a vacuum line fluidly connected to a top portion of the vessel, whereby opening the vacuum line using a valve imparts negative pressure to the vacuum vessel; (c) a water delivery conduit fluidly connected at one end to a water source and at its other end to the vessel interior; and (d) a water removal conduit fluidly connected at one end to the vessel interior and at its other end to a pump.

### CROSS-REFERENCE TO RELATED APPLICATIONS/INCORPORATION BY REFERENCE

This application claims priority benefits from U.S. Provisional Patent Application Ser. No. 61/239,064 filed Sep. 2, 2009, entitled “Vacuum Saturation Technique For Porous Aggregate Material”. The '064 provisional application is hereby incorporated by reference herein in its entirety.

### FIELD OF THE INVENTION

The present invention relates to the manufacture of concrete. In particular, the present invention relates to the saturation of porous aggregate material employed in the manufacture of concrete.

### BACKGROUND OF THE INVENTION

In the manufacture of concrete, the use of lightweight aggregate material is preferred because the resulting concrete will be lighter than conventional concrete (110-120 lbs/ft³ versus 150 lbs/ft³), thereby reducing trucking and transportation costs for building panels and other products formed from lighter weight concrete.

Expanded slag material available in the Midwestern U.S. is a source of porous aggregate material employable in the manufacture of concrete. The problem with porous aggregate material is its tendency to suck the water out of the cement paste, thereby preventing adequate hydration for curing. In that case, the final strength of the resulting concrete products is unacceptable. Other lightweight, porous aggregate materials, such as expanded shale, are also available and have similar bulk density characteristics.

In a concrete pump application, the high pressure during pumping can force water into the aggregate material. This results in the concrete drying before it is out of the pipeline, thereby increasing the probability that the dried concrete will clog the pipeline.

In the present technique, the porous aggregate material is pre-saturated so water fills the pores. Using pressure on a large scale to pre-saturate the porous aggregate material is not effective, however. Neither is soaking the porous aggregate material in a bin or spraying the surface with water.

### SUMMARY OF THE INVENTION

Embodiments of the present technology provide methods and systems for saturating porous aggregate material. In an embodiment, a method of saturating porous aggregate material includes: (a) filling an interior of a vacuum vessel with porous aggregate material; (b) applying a vacuum to said vessel interior until a desired vacuum level is reached; (c) drawing water into said vessel under vacuum until substantially all of said aggregate material is covered; and (d) pumping unabsorbed water from said vacuum vessel.

In an embodiment, the vacuum level is at least about 20 inHg.

In an embodiment, the vacuum vessel is filled to at least about 75% of a volume of the vacuum vessel.

In an embodiment, the water is provided to the vacuum vessel and pumped out of the vacuum vessel using a water conduit.

In an embodiment, the water conduit includes a slotted pipe extending from a lower portion of the vacuum vessel to an upper portion of the vacuum vessel.

In an embodiment, the unabsorbed water is pumped from the vacuum vessel after the aggregate material is saturated with water so as to have a bulk density of about 53-57 lbs/cu-ft.

In an embodiment, the unabsorbed water is pumped from the vacuum vessel after the aggregate material is covered by the water for at least about 60 seconds.

In an embodiment, the method further includes filtering the unabsorbed water to remove particulate matter.

In an embodiment, the method further includes delivering the porous aggregate material to the vacuum vessel using a conveyor.

In an embodiment, the method further includes moving porous aggregate material emptied from the vacuum vessel using a conveyor.

In an embodiment, a system for saturating porous aggregate materials includes: (a) a vacuum vessel having an aggregate material inlet at an upper portion thereof, said inlet having a valve associated therewith for permitting said vessel interior to be filled when said vessel inlet valve is in an open position, and an aggregate material outlet at a lower portion thereof, said outlet having a valve associated therewith for permitting said vessel interior to be emptied when said vessel outlet valve is in an open position; (b) a vacuum line fluidly connected to a top portion of said vessel, said vacuum line having a valve associated therewith for applying vacuum to said vessel interior when said vacuum line valve is in an open position; (c) a water delivery conduit fluidly connected at one end to a water source and at its other end to said vessel interior, said water delivery conduit having a valve associated therewith for permitting water flow to said vessel interior when said water delivery conduit valve is in an open position; (d) a water removal conduit fluidly connected at one end to said vessel interior and at its other end to a pump, said water removal conduit having a valve associated therewith for effecting removal of water from said vessel interior upon actuation of said pump, whereby opening said vacuum line valve when porous aggregate material is present in said vessel interior imparts negative pressure to said aggregate material such that upon closing said vacuum line valve and opening said water delivery conduit valve, water is drawn into said vessel interior to saturate said porous aggregate material, and actuating said pump thereafter removes unabsorbed water from said vessel.

In an embodiment, the water delivery conduit and said water removal conduit are connected at a bottom portion of said vessel.

In an embodiment, the water delivery conduit and said water removal conduit are one water conduit, said water delivery conduit valve and said water removal conduit valve are one water conduit valve, and said pump is interposed in said one water conduit.

In an embodiment, the one water conduit is connected at a bottom portion of said vessel.

In an embodiment, the pump has a strainer disposed upstream thereof such that particulate matter present in said water removal conduit is impeded from entering said pump.

In an embodiment, the water delivery conduit and said water removal conduit are in fluid communication with a slotted pipe extending from the lower portion of the vacuum vessel to the upper portion of the vacuum vessel, the slotted pipe configured to deliver and remove water from the vacuum vessel via the slots.

In an embodiment, the system further includes a conveyor configured to deliver porous aggregate material to the vacuum vessel.

In an embodiment, the system further includes a conveyor configured to move porous aggregate material that has been emptied from the vacuum vessel.

In an embodiment, the vacuum line is configured to impart negative pressure to said vacuum vessel until a vacuum level of at least about 20 inHg is achieved.

In an embodiment, the system further includes (e) a second vacuum vessel having an aggregate material inlet at an upper portion thereof, said second vessel inlet having a valve associated therewith for permitting said second vessel interior to be filled when said second vessel inlet valve is in an open position, and an aggregate material outlet at a lower portion thereof, said second vessel outlet having a valve associated therewith for permitting said second vessel interior to be emptied when said second vessel outlet valve is in an open position; (f) a second vacuum line fluidly connected to a top portion of said second vessel, said second vacuum line having a valve associated therewith for applying vacuum to said second vessel interior when said second vacuum line valve is in an open position; (c) a second water delivery conduit fluidly connected at one end to the water source and at its other end to said second vessel interior, said second water delivery conduit having a valve associated therewith for permitting water flow to said second vessel interior when said second water delivery conduit valve is in an open position; (d) a second water removal conduit fluidly connected at one end to said second vessel interior and at its other end to said pump, said second water removal conduit having a valve associated therewith for effecting removal of water from said second vessel interior upon actuation of said pump, whereby opening said second vacuum line valve when porous aggregate material is present in said second vessel interior imparts negative pressure to said aggregate material such that upon closing said second vacuum line valve and opening said second water delivery conduit valve, water is drawn into said second vessel interior to saturate said porous aggregate material, and actuating said pump thereafter removes unabsorbed water from said second vessel.

In an embodiment, the first vacuum vessel and the second vacuum vessel are configured such that they can be operated simultaneously.

In an embodiment, the first vacuum vessel and the second vacuum vessel are configured such that they can be operated one at a time.

### BRIEF DESCRIPTION OF THE DRAWING(S)

FIG. 1 is a schematic diagram of a system for saturating porous aggregate material used in accordance with an embodiment of the present technology.

FIGS. 2-6 are schematic diagrams of steps involved in a technique for saturating porous aggregate material used in accordance with an embodiment of the present technology.

FIG. 7 is a schematic diagram of a system for saturating porous aggregate material used in accordance with an embodiment of the present technology.

### DETAILED DESCRIPTION OF PREFERRED EMBODIMENT(S)

The present invention relates to the manufacture of concrete. In particular, the present invention relates to the saturation of porous aggregate material employed in the manufacture of concrete.

It has been found that expanded slag aggregate used in the manufacture of concrete should preferably have an initial bulk density of about 53-57 lbs/cu-ft so that water added in batching for cement paste hydration is not overly absorbed by the aggregate. However, expanded slag material available in the Midwestern U.S. has a dry bulk density of about 47 lbs/cu-ft, and, in practice, expanded slag material delivered for use in the manufacture of concrete will have a bulk density between 47-50 lbs/cu-ft. Due to the porosity of the aggregate, if the aggregate is completely saturated, the aggregate will have a bulk density of about 57 lbs/cu-ft. This represents over 21% increase in weight due to moisture content.

It has been found that placing aggregate in a vacuum vessel at a pressure of about 20-27 inches of mercury (in Hg) and then filling the vessel with water, can satisfactorily saturate aggregate for use in concrete manufacturing. For example, in certain embodiments, aggregate and water can be retained in a vacuum vessel for 5 minutes at a vacuum pressure of about 20 inHg in order to saturate the aggregate to a bulk density of about 53-57 lbs/cu-ft. For example, in certain embodiments, aggregate and water can be retained in a vacuum vessel for 1 minute at a vacuum pressure of about 27 inHg in order to saturate the aggregate to a bulk density of about 53-57 lbs/cu-ft. For example, in certain embodiments, pressure and time can be varied linearly (for example, such that a pressure of 23.5 inHg corresponds to a saturation time of 3 minutes) in order to saturate the aggregate to a bulk density of about 53-57 lbs/cu-ft.

Embodiments of the present technology further describe systems and methods for saturation of porous aggregate material employed in the manufacture of concrete. In the figures, like elements have like identifiers.

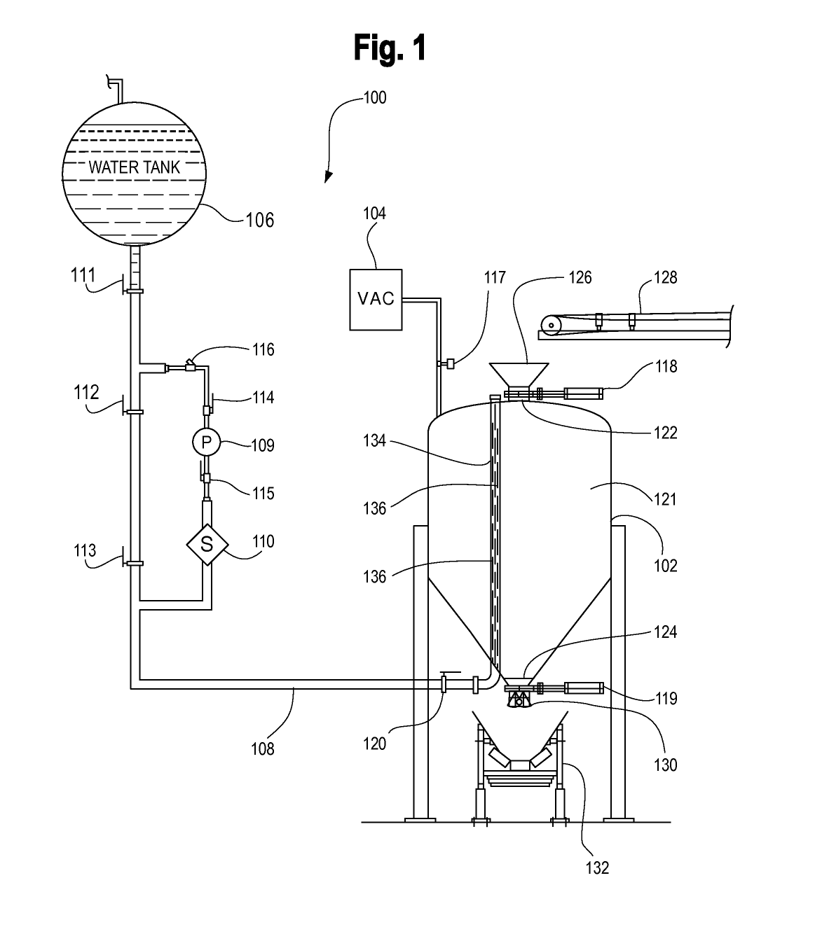

FIG. 1 is a schematic diagram of a system 100 for saturating porous aggregate material used in accordance with an embodiment of the present technology. System 100 includes a vacuum vessel 102, a vacuum 104, a water supply 106, a water delivery/removal conduit 108, a pump 109, a strainer 110, and a plurality of valves 111, 112, 113, 114, 115, 116, 117, 118, 119 and 120.

Vacuum vessel 102 includes an interior 121, an inlet 122, and an outlet 124. In certain embodiments, the vessel interior 121 can have a volume that is about 2000 cubic feet, and can be filled with up to about 50 tons of aggregate. Vessel inlet 122 has a valve 118 associated therewith and is configured to allow aggregate material to be provided to the vessel interior 121 when valve 118 is in an open position. Aggregate material can be supplied, for example, from a hopper 126 and a conveyor 128, where conveyor 128 delivers aggregate to hopper 126, and the aggregate passes thorough hopper 126 prior to passing through vessel inlet 122. Vessel outlet 124 has a valve 119 associated therewith and is configured to allow aggregate material to be emptied from the vessel interior 121 when valve 119 is in an open position. Aggregate material can be emptied through a clamshell gate 130 into a weigh conveyor 132, for example. In certain embodiments, valves 118 and 119 can be knife gate valves.

Vessel interior 121 is operably connected to vacuum 104 such that vacuum 104 can be applied to vessel interior 121 until a desired vacuum level within vessel interior 121 is achieved. Valve 117 is a shut-off valve disposed between vacuum 104 and vessel interior 121. Valve 117 can allow vacuum 104 to be applied to vessel interior 121 when in an open position and stop vacuum 104 from being applied to vessel interior 121 when in a closed position. In certain embodiments, vacuum 104 can be applied to vessel interior 121 until a vacuum level of about 20-27 inHg is achieved.

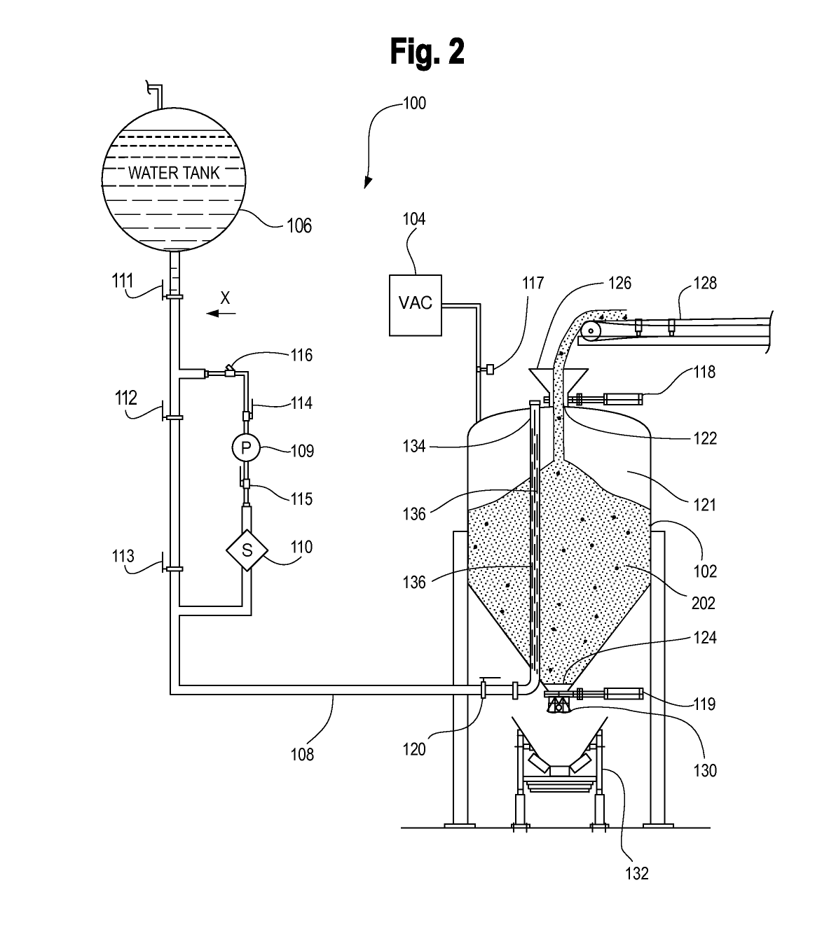

Vessel interior 121 is in fluid communication with water supply 106 via water delivery/removal conduit 108. Pump 109 and strainer 110 are also in fluid communication with water supply 106 via water delivery/removal conduit 108. Water delivery/removal conduit 108 has parallel paths and a plurality of valves (111, 112, 113, 114, 115, 117 and 120) that are configured such that water being delivered to vessel interior 121 does not pass through pump 109, and water being removed from vessel interior 121 does pass through strainer 110 and pump 109. Valves 111, 112, 113, 114, 115 and 120 are shut off valves that can allow water to pass through when in an open position and stop water from passing through when in a closed position. Valve 117 is a check valve that can allow water to pass through in one direction only. In system 100, check valve 117 only allows water to pass through toward water supply 106 and away from pump 109. That is, check valve 117 only allows water to pass through in the direction X. Operation of the valves when using system 100 will be described in more detail in connection with FIGS. 2-6. While a single water delivery/removal conduit 108 with parallel paths is depicted in system 100, in certain embodiments, a water delivery conduit can be completely separate from a water removal conduit. In certain embodiments, water supply 106 can be elevated relative to vacuum vessel such that gravity and the pull of vacuum 104 can cause water to flow from water supply 106 to vessel interior 121 when the water valves are open. In certain embodiments, water supply 106 can be a pressurized water supply such that gravity, the pull of vacuum 104 and the pressure from the water supply cause water to flow from water supply 106 to vessel interior 121 when the water valves are open.

Water delivery/removal conduit 108 extends into vessel interior 121 and, inside vessel interior 121, comprises a pipe 134 with a plurality of slots 136 through which water is delivered from pipe 134 to vessel interior 121 and through which water is removed from vessel interior 121 by pipe 134. In certain embodiments, pipe 134 can be a 5 inch diameter, schedule 80 pipe. In certain embodiments, each slot 136 can be ⅛ of an inch wide and 12 inches long, extending lengthwise about pipe 134.

FIGS. 2-6 are schematic diagrams of steps involved in a technique for saturating porous aggregate material used in accordance with an embodiment of the present technology.

FIG. 2 depicts system 100 while aggregate 202 is being delivered to vessel interior 121. At this stage, valves 111, 112, 113, 114, 115 and 120 are closed such that water is not being delivered to or removed from vessel interior 121. Valve 117 is closed such that vacuum 104 is not being applied to vessel interior 121. Valve 119 is closed such that aggregate 202 will not pass through vessel outlet 124 and will be retained in vessel interior 121. Valve 118 is open such that aggregate 202 can be delivered to vessel interior 121 through vessel inlet 122. Conveyor 128 is aligned with hopper 126 and run such that aggregate 202 can be delivered to vessel interior 121. Conveyor 128 can continue to deliver aggregate 202 until a desired fill level is achieved. In certain embodiments, the aggregate fill level can be no greater than about 75% of the total capacity of vessel interior 121.

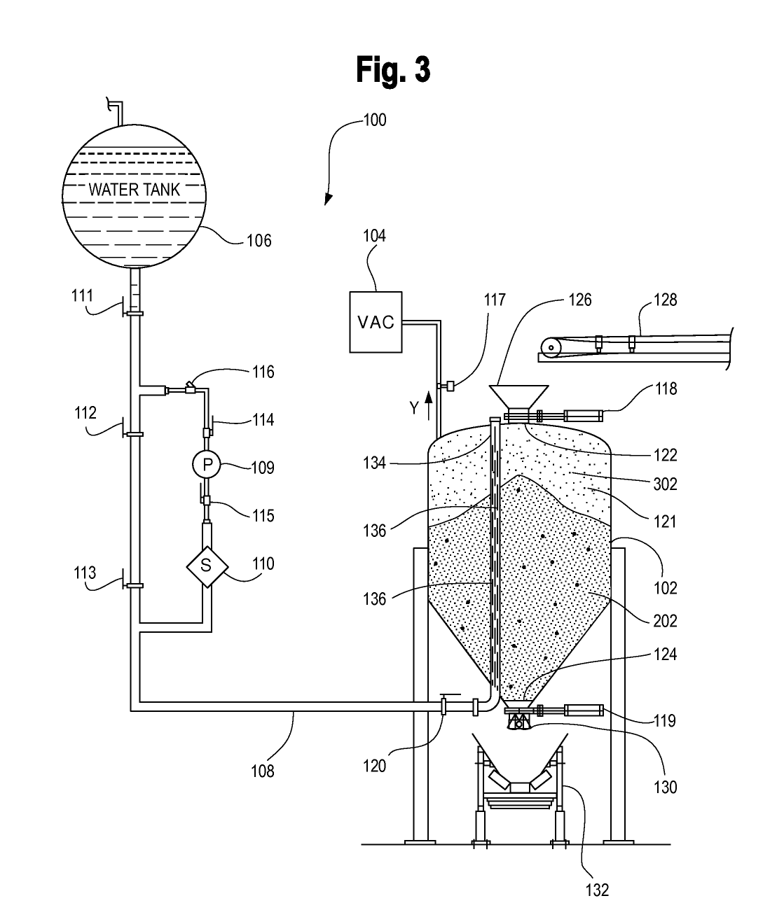

FIG. 3 depicts system 100 after aggregate 202 has been delivered to vessel interior 121, and while vacuum 104 is being applied to vessel interior 121. At this stage, valves 111, 112, 113, 114, 115 and 120 are closed such that water is not being delivered to or removed from vessel interior 121. Conveyor 128 is no longer delivering aggregate 202. Valve 118 is closed such that aggregate cannot be delivered to vessel interior 121 through vessel inlet 122. Valve 119 remains closed such that aggregate will not pass through vessel outlet 124 and will be retained in vessel interior 121. Valve 117 is opened to allow vacuum 104 to be applied to vessel interior 121. Vacuum 104 is turned on such that air is removed from vessel interior 121 (in the direction Y) until a desired vacuum level inside vessel interior 121 is achieved. Air inside the vessel interior 121 at a desired vacuum level is indicated by 302. In certain embodiments, the vacuum level can be about 20-27 inches of mercury (inHg).

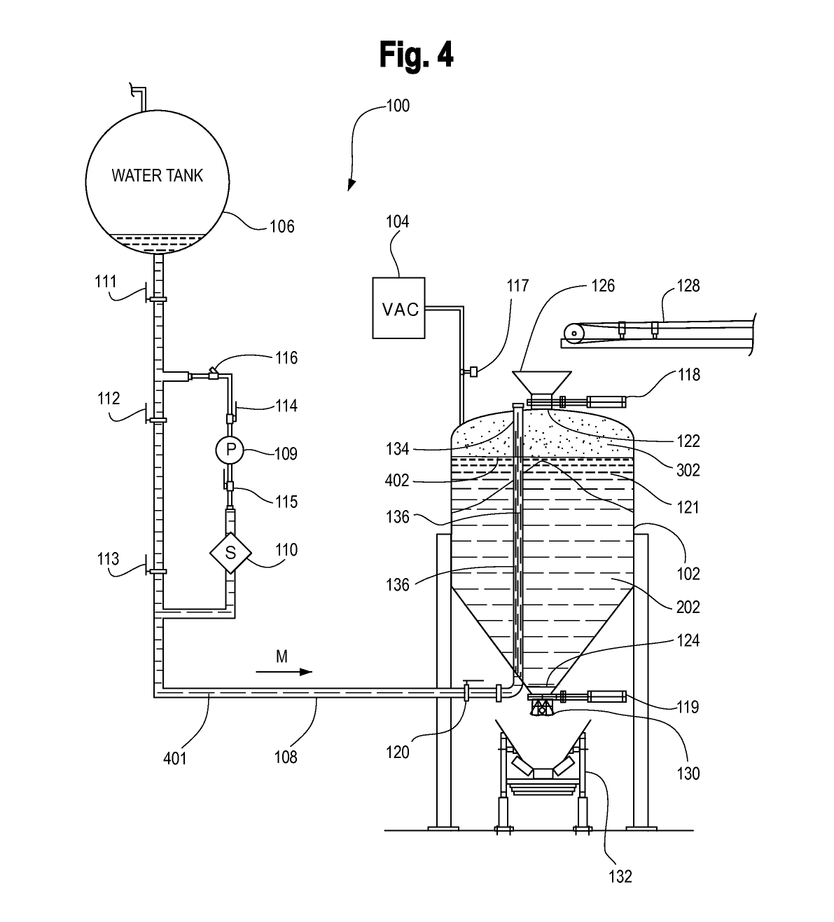

FIG. 4 depicts system 100 after vacuum 104 has been applied to vessel interior 121, and while water is being delivered to vessel interior 121 from water supply 106. At this stage, valve 117 is closed such that vacuum 104 is not being further applied to vessel interior 121. Valve 118 remains closed such that aggregate cannot be delivered to vessel interior 121 through vessel inlet 122. Valve 119 remains closed such that aggregate will not pass through vessel outlet 124 and will be retained in vessel interior 121. Valves 111, 112, 113 and 120 are open and valves 114 and 115 are closed such that water 401 is being delivered to vessel interior 121 from water supply 106 via water conduit 108 without passing through pump 109. Water 401 flows in direction M and is delivered to vessel interior 121 via slots 136 in pipe 134. Water 401 can be delivered to vessel interior 121 until a desired fill level is achieved. The water fill level should be sufficient to cover the aggregate 202 in vessel interior 121, as depicted, for example, by water fill level 402. Aggregate 202 can be saturated by water 401 provided in vessel interior 121 at the desired vacuum level. In certain embodiments, the aggregate and water can be held in this state for about 1-5 minutes depending on the vacuum level (for example, 20-27 inHg) to promote full saturation of the aggregate.

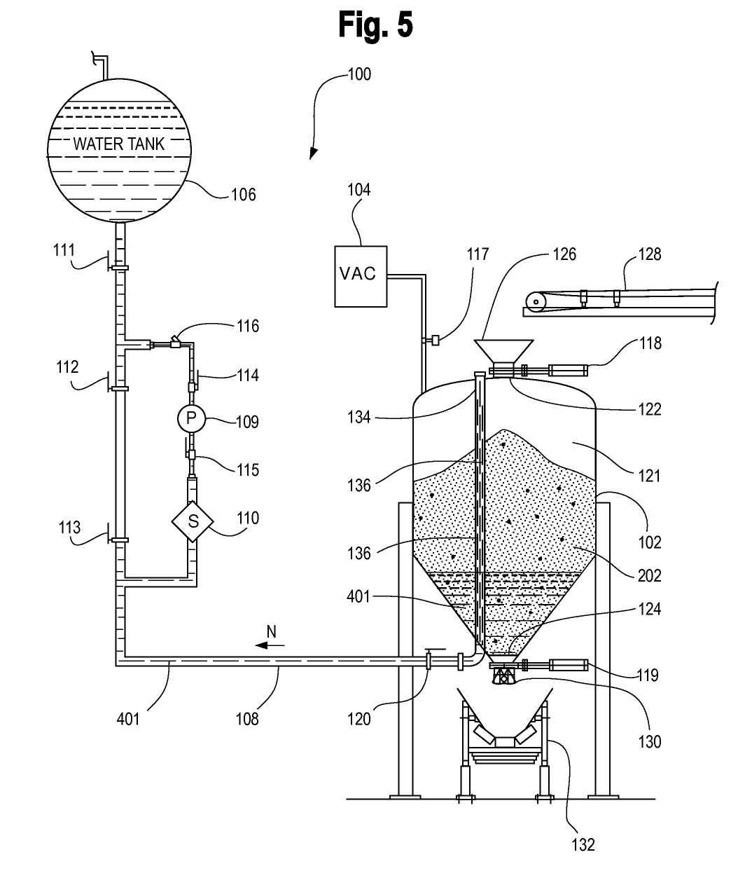

FIG. 5 depicts system 100 after aggregate 202 has been saturated, and while water is being removed from vessel interior 121. At this stage, valve 117 remains closed such that vacuum 104 is not being further applied to vessel interior 121. Valve 119 remains closed such that aggregate will not pass through vessel outlet 124 and will be retained in vessel interior 121. Valve 118 is open such that ambient air can flow into vessel interior 121 through vessel inlet 122. Valves 112, 113 are closed and valves 111, 114, 115 and 120 are open such that water 401 is being removed from vessel interior 121 by pump 109 via water conduit 108. Pump 109 is turned on such that water is drawn in direction N from vessel interior 121 via slots 136 in pipe 134. Water 401 continues to be drawn until excess water 401 is removed from vessel interior 121. Although slots 136 in pipe 134 act as a filter that does not allow large particles to enter water conduit 108, some smaller particulate matter may still enter water conduit 108. Thus, strainer 110 is disposed upstream from pump 109 such that strainer 110 can filter particulate matter from water 401 prior to water 401 passing through pump 109. In certain embodiments, slots 136 in pipe 134 can be configured to filter particulate matter larger than ⅛ of an inch in diameter from water 401. In certain embodiments, strainer 110 can be configured to filter particulate matter larger than 1/32 of an inch in diameter from water 401.

The amount of water 401 that returns to water supply 106 is less than the amount originally delivered because aggregate 202 has been saturated and retains some water. Thus, after remaining water 401 has been returned to water supply 106, water supply 106 can be topped off from a separate water supply in order to replenish the water that remained in the aggregate 202.

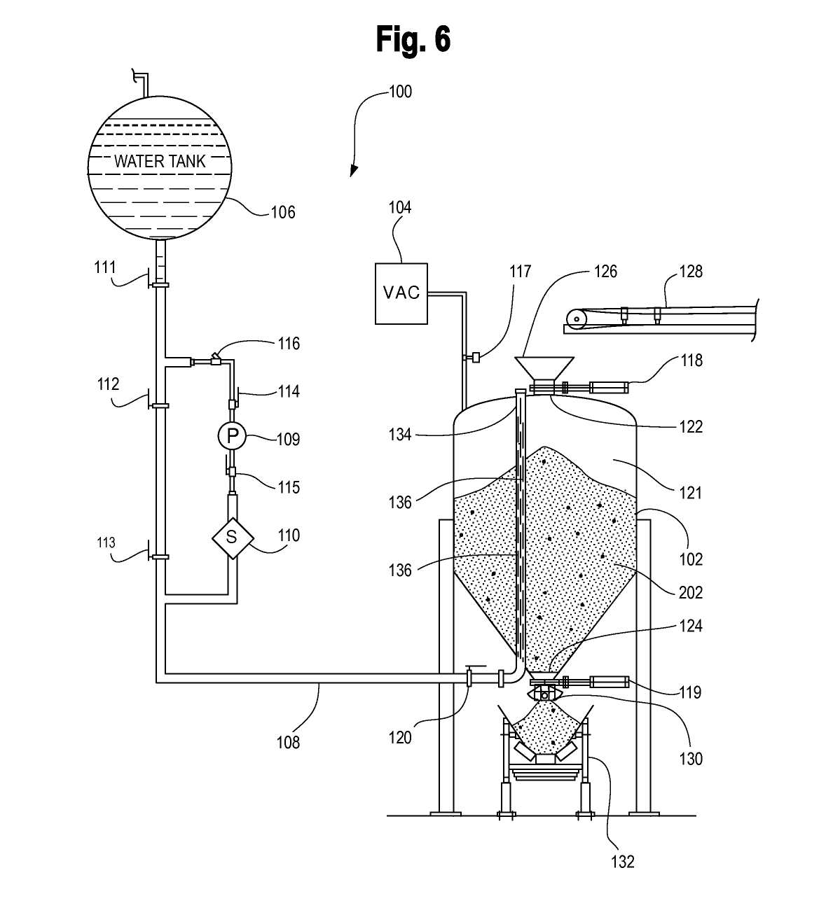

FIG. 6 depicts system 100 after water has been removed from vessel interior 121, and while aggregate is being removed from vessel interior 121. At this stage, valve 117 remains closed such that vacuum 104 is not being further applied to vessel interior 121. Valve 118 remains open such that ambient air can flow into vessel interior 121 through vessel inlet 122. Valves 111, 112, 113, 114, 115 and 120 are closed such that water is not being delivered to or removed from vessel interior 121. Valve 119 is open such that aggregate 202 can pass through vessel outlet 124 and will be emptied from vessel interior 121. Aggregate 202 can be emptied onto weigh conveyor 132 via clamshell gate 130, which can be used to regulate the flow of aggregate onto weigh conveyor 132. In certain embodiments, clamshell gate 130 can be configured to allow 6000 lbs/min of aggregate to flow onto weigh conveyor 132.

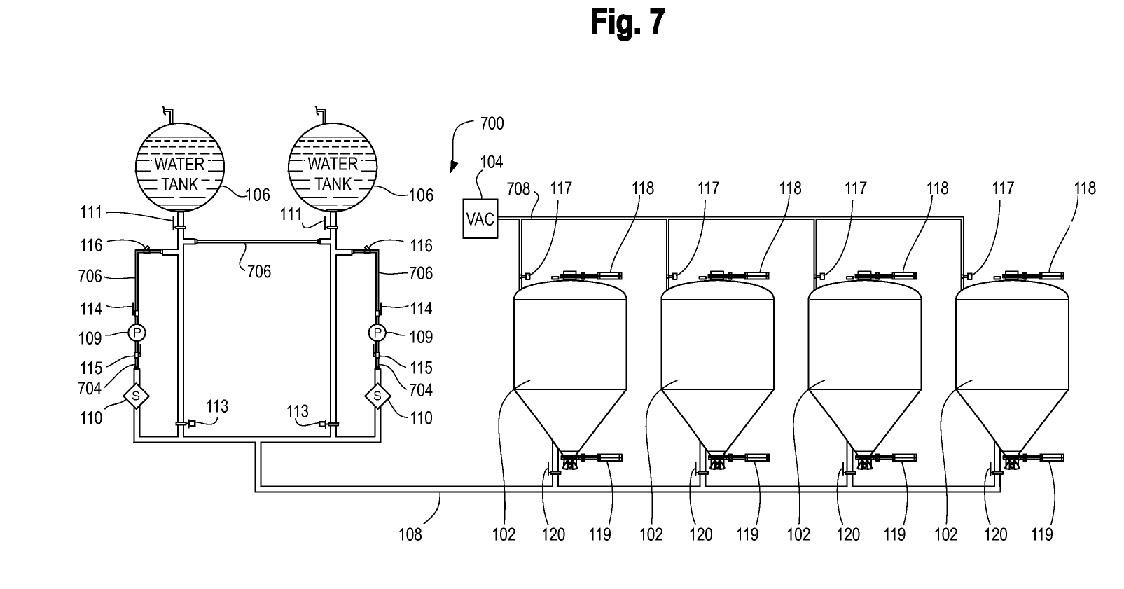

FIG. 7 is a schematic diagram of a system 700 for saturating porous aggregate material used in accordance with an embodiment of the present technology. The system 700 includes two water supplies 106 in fluid communication with four vacuum vessels 102 via water conduit 108. In certain embodiments, water conduit 108 can comprise pipe of different diameters. For example, in the embodiment shown, water conduit 108 includes 5 inch diameter pipe 702, 3 inch diameter pipe 704 and 2.5 inch diameter pipe 706. Vacuum 104 is operably connected to the four vacuum vessels 102, for example, using 1.5 inch diameter pipe 708. In the manner shown, or in other similar fashion, any number of water supplies can be paired with any number of vacuum vessels, and a vacuum can be paired with any number of vacuum vessels. The piping and valves can allow the vacuum vessels to be utilized one at time or simultaneously as desired for concrete production purposes.

In certain embodiments, operating the systems and/or applying the methods described herein can provide for improved manufacture of lightweight concrete with acceptable strength and reduced probability that dried concrete will clog the pipeline during manufacture.

While particular elements, embodiments and applications of the present invention have been shown and described, it will be understood that the invention is not limited thereto since modifications can be made by those skilled in the art without departing from the scope of the present disclosure, particularly in light of the foregoing teachings.

What is claimed is:

1. A method of saturating porous aggregate material comprising:
(a) filling an interior of a vacuum vessel with porous aggregate material;
(b) applying a vacuum to said vessel interior until a desired vacuum level is reached;
(c) drawing water into said vessel under vacuum until substantially all of said aggregate material is covered; and
(d) pumping unabsorbed water from said vacuum vessel.

2. The method of claim 1, wherein said vacuum level is at least about 20 inHg.

3. The method of claim 1, wherein said vacuum vessel is filled to at least about 75% of a volume of the vacuum vessel.

4. The method of claim 1, wherein the water is provided to the vacuum vessel and pumped out of the vacuum vessel using a water conduit.

5. The method of claim 4, wherein the water conduit includes a slotted pipe extending from a lower portion of the vacuum vessel to an upper portion of the vacuum vessel.

6. The method of claim 1, wherein the unabsorbed water is pumped from the vacuum vessel after the aggregate material is saturated with water so as to have a bulk density of about 53-57 lbs/cu-ft.

7. The method of claim 1, wherein the unabsorbed water is pumped from the vacuum vessel after the aggregate material is covered by the water for at least about 60 seconds.

8. The method of claim 1, further comprising filtering the unabsorbed water to remove particulate matter.

9. The method of claim 1, further comprising delivering the porous aggregate material to the vacuum vessel using a conveyor.

10. The method of claim 1, further comprising moving porous aggregate material emptied from the vacuum vessel using a conveyor.

11. A system for saturating porous aggregate materials comprising:
(a) a vacuum vessel having an aggregate material inlet at an upper portion thereof, said inlet having a valve associated therewith for permitting said vessel interior to be filled when said vessel inlet valve is in an open position, and an aggregate material outlet at a lower portion thereof, said outlet having a valve associated therewith for permitting said vessel interior to be emptied when said vessel outlet valve is in an open position;
(b) a vacuum line fluidly connected to a top portion of said vessel, said vacuum line having a valve associated therewith for applying vacuum to said vessel interior when said vacuum line valve is in an open position;
(c) a water delivery conduit fluidly connected at one end to a water source and at its other end to said vessel interior, said water delivery conduit having a valve associated therewith for permitting water flow to said vessel interior when said water delivery conduit valve is in an open position;
(d) a water removal conduit fluidly connected at one end to said vessel interior and at its other end to a pump, said water removal conduit having a valve associated therewith for effecting removal of water from said vessel interior upon actuation of said pump,
whereby opening said vacuum line valve when porous aggregate material is present in said vessel interior imparts negative pressure to said aggregate material such that upon closing said vacuum line valve and opening said water delivery conduit valve, water is drawn into said vessel interior to saturate said porous aggregate material, and actuating said pump thereafter removes unabsorbed water from said vessel.

12. The saturation system of claim 11, wherein said water delivery conduit and said water removal conduit are connected at a bottom portion of said vessel.

13. The saturation system of claim 11, wherein said water delivery conduit and said water removal conduit are one water conduit, said water delivery conduit valve and said water removal conduit valve are one water conduit valve, and said pump is interposed in said one water conduit.

14. The saturation system of claim 11, wherein said one water conduit is connected at a bottom portion of said vessel.

15. The saturation system of claim 11, wherein said pump has a strainer disposed upstream thereof such that particulate matter present in said water removal conduit is impeded from entering said pump.

16. The saturation system of claim 11, wherein said water delivery conduit and said water removal conduit are in fluid communication with a slotted pipe extending from the lower portion of the vacuum vessel to the upper portion of the vacuum vessel, the slotted pipe configured to deliver and remove water from the vacuum vessel via the slots.

17. The saturation system of claim 11, further comprising a conveyor configured to deliver porous aggregate material to the vacuum vessel.

18. The saturation system of claim 11, further comprising a conveyor configured to move porous aggregate material that has been emptied from the vacuum vessel.

19. The saturation system of claim 11, wherein said vacuum line is configured to impart negative pressure to said vacuum vessel until a vacuum level of at least about 20 inHg is achieved.

20. The saturation system of claim 11, further comprising:
(e) a second vacuum vessel having an aggregate material inlet at an upper portion thereof, said second vessel inlet having a valve associated therewith for permitting said second vessel interior to be filled when said second vessel inlet valve is in an open position, and an aggregate material outlet at a lower portion thereof, said second vessel outlet having a valve associated therewith for permitting said second vessel interior to be emptied when said second vessel outlet valve is in an open position;
(f) a second vacuum line fluidly connected to a top portion of said second vessel, said second vacuum line having a valve associated therewith for applying vacuum to said second vessel interior when said second vacuum line valve is in an open position;
(g) a second water delivery conduit fluidly connected at one end to the water source and at its other end to said second vessel interior, said second water delivery conduit having a valve associated therewith for permitting water flow to said second vessel interior when said second water delivery conduit valve is in an open position;
(h) a second water removal conduit fluidly connected at one end to said second vessel interior and at its other end to said pump, said second water removal conduit having a valve associated therewith for effecting removal of water from said second vessel interior upon actuation of said pump,
whereby opening said second vacuum line valve when porous aggregate material is present in said second vessel interior imparts negative pressure to said aggregate material such that upon closing said second vacuum line valve and opening said second water delivery conduit valve, water is drawn into said second vessel interior to saturate said porous aggregate material, and actuating said pump thereafter removes unabsorbed water from said second vessel.

21. The saturation system of claim 20, wherein the first vacuum vessel and the second vacuum vessel are configured such that they can be operated simultaneously.

22. The saturation system of claim 20, wherein the first vacuum vessel and the second vacuum vessel are configured such that they can be operated one at a time.
